(19) United States
(12) Patent Application Publication
(10) Pub. No.: US 2018/0168004 A1
(43) Pub. Date: Jun. 14, 2018

(54) Heater Tube for Molten Metal Immersion

(71) Applicant: Mitsui Mining & Smelting Co., Ltd., Tokyo (JP)

(72) Inventors: Eiki Tsutsumi, Omuta-shi (JP); Hitoshi Kajino, Omuta-shi (JP)

(21) Appl. No.: 15/643,751

(22) Filed: Jul. 7, 2017

(30) Foreign Application Priority Data
Dec. 9, 2016 (JP) 2016-239115

(51) Int. Cl. H05B 3/44; B01J 2/04; B28B 3/00; C04B 35/584; F27B 14/06; F27B 14/14

(52) U.S. Cl. CPC H05B 3/44; B01J 2/04; B28B 3/003; C04B 2235/3445; F27B 14/06; F27B 14/14; C04B 2235/3225; C04B 35/584

(57) ABSTRACT

A heater tube for molten metal immersion 1 has a cylindrical heater housing part 4 equipped with a closed end 2 and an open end 3, wherein the heater housing part 4 comprises silicon nitride, a compound comprising yttrium, and a compound comprising magnesium. The heater housing part 4 has a surface roughness Ra of an outer circumferential surface of the heater housing part 4 is between 0.5 μm and 10 μm, inclusive.

### CROSS-REFERENCE TO RELATED APPLICATION

This application claims priority to Japanese Patent Application No. 2016-239115 filed Dec. 9, 2016, the disclosure of which is hereby incorporated in its entirety by reference.

### TECHNICAL FIELD

The present invention relates to a heater tube for molten metal immersion which protects a heater immersed in molten metal such as aluminum.

### BACKGROUND ART

A heater tube is immersed in molten metal such as an aluminum molten metal, and is used for protecting the inside of a heater. Since the heater tube is immersed in high temperature molten metal, it is necessary to be produced by materials in which mechanical strength is high, thermal shock resistance, abrasion resistance and the like are excellent, and thermal conductivity is high. Therefore, a silicon nitride-based sintered body (Si₃N₄) or the like is often used for the heater tube.

For example, the following Patent Document 1 discloses a heater tube which is composed of a silicon nitride-based sintered body having a columnar crystal containing silicon nitride as a main component and a grain boundary phase containing an oxide of a metal element as a main component, wherein the silicon nitride-based sintered body has open pores, and a plurality of the second columnar crystals having a larger diameter than the first columnar crystal present inside the silicon nitride-based sintered body are present so as to cross each other.

The following Patent Document 2 discloses a method for producing a silicon nitride-boron nitride composite ceramic in which a composite ceramic of silicon nitride and boron nitride is obtained by mixing, forming and calcining raw material powders comprising silicon nitride powders, sintering aid powders and hexagonal boron nitride powders, wherein the hexagonal boron nitride in which an average particle diameter measured by a laser diffraction and scattering method is 2 to 10 μm, a particle having a particle diameter of 30 μm or more is 5% or less, an average particle size of a primary particle measured from an SEM photograph is 0.01 to 0.8 μm, and a specific surface area is 20 to 50 m²/g is contained at 3 to 20 parts by mass with respect to 100 parts by mass in total of the silicon nitride powders and the sintering aid powders, and discloses a member for molten metal using the silicon nitride-boron nitride composite ceramic.

### CITATION LIST

### Patent Document

Patent Document 1: Japanese Patent Application Laid-Open No. 2012-106920
Patent Document 2: Japanese Patent Application Laid-Open No. 2012-51758

As such, a silicon nitride-based sintered body is generally used for the heater tube for molten metal immersion because of the high mechanical strength.

The heater tube is immersed into molten metal, and conducts an amount of heat of the heater to the molten metal, and thus a thermal conductivity thereof is preferably high from a viewpoint of conducting heat effectively.

Although the heater tube sintered body is being densified by a sintering aid, the sintering aid has a disadvantage of extremely reducing thermal conductivity of the materials, and thus it is required for reducing an amount of the sintering aid from a viewpoint of enhancing thermal conductivity.

However, when an amount of the sintering aid is reduced in the silicon nitride-based sintered body, and calcined under calcination conditions in the same manner as conventional ones, a silicon nitride-based sintered body having high density cannot be obtained since an amount of the sintering aid is small. In order to have high density while reducing an amount of the sintering aid, it is necessary to calcine at a higher temperature than a conventional one. However, when the temperature is raised to a temperature with a density-improving effect, problems that silicon nitride (Si₃N₄) is decomposed, an outer circumferential surface is roughed, a surface roughness Ra becomes large, bubbles are easily gathered between an outer surface of the heater tube and the molten metal, and then it becomes hard to conduct heat to the molten metal, are occurred.

The present inventors researched earnestly and discovered a method for producing a silicon nitride-based sintered body having high density and high thermal conductivity even if an amount of a sintering aid was reduced in the silicon nitride-based sintered body. The structure and properties of the silicon nitride-based sintered body were analyzed, and unconventional characteristics were discovered.

Therefore, the present invention is intended to provide a heater tube for molten metal immersion comprising a silicon nitride-based sintered body in which the thermal conductivity and the density are higher than that of conventional products.

### SUMMARY OF THE INVENTION

The heater tube for molten metal immersion according to an embodiment of the present invention is a heater tube for molten metal immersion having a cylindrical heater housing part equipped with a closing end and an opening end, wherein the heater housing part comprises silicon nitride, a compound comprising yttrium, and a compound comprising magnesium, and a surface roughness Ra of an outer circumferential surface of the heater housing part is 0.5 μm or more and 10 μm or less.

In the heater tube for molten metal immersion of the above embodiment, the surface roughness Ra of the outer circumferential surface of the heater housing part has been set to 0.5 μm or more and 10 μm or less. It is considered that this is because when the surface roughness Ra of the outer circumferential surface is 10 μm or more, bubbles are gathered at the outer circumferential surface and it becomes hard to conduct heat, and when the surface roughness Ra of the outer circumferential surface is 0.5 μm or less, an oxide of the molten metal generated at the surface of the heater tube is hardly peeled off, and thus thermal conduction to the molten metal which should be heated worsens by existing such an oxide layer.

In the heater tube for molten metal immersion of the above embodiment, it is preferable that yttrium is 1.0 wt. % or more and 5.0 wt. % or less, magnesium is 0.5 wt. % or more and 5.0 wt. % or less which are respectively comprised in the heater housing part, and the balance excluding the yttrium and the magnesium is only the silicon nitride of 75 wt. % or more and inevitable impurities. When a composition is out of these ranges, for example, when magnesium is less than 0.5 wt. %, a function as a sintering aid is insufficient, open pores and closed pores remain, and as a result, thermal conductivity becomes low. In addition, for example, when yttrium or magnesium is more than 5.0 wt. %, an amount of the sintering aid becomes too large, and thus closed pores are easily generated. Also, grain boundary phases caused by the sintering aid in the sintered body increase too much, and as a result, thermal conductivity becomes low.

Further, it is preferable that a compound comprising the yttrium is Y₂Si₃O₃N₄ or Y₄Si₂O₇N₂. By having such a composition, a silicon nitride-based sintered body having higher density and higher thermal conductivity than those of conventional products can be obtained even when using the same amount of the sintering aid.

In the heater tube for molten metal immersion of the above embodiment, it is preferable that a closed porosity of the heater housing part is 15% or less, a surface roughness Ra of an inner circumferential surface of the heater housing part is 0.5 μm or more and 4.0 μm or less, a thermal conductivity of the heater housing part is 50 W/(m·K) or more, a bending strength of the heater housing part is 500 MPa or more, a fracture toughness of the heater housing part is 5 MPa·(m)^{(1/2)} or more, and an open porosity of the heater housing part is 3% or less. By having such physical properties, a heater tube for molten metal immersion having strength and improved thermal conductivity is provided.

In the heater tube for molten metal immersion of the above embodiment, it is preferable that a length is 200 mm or more and 2,000 mm or less, an outer diameter is 15 mm or more and 200 mm or less, and a thickness is 3 mm or more and 20 mm or less, and even with such a size, a heater tube for molten metal immersion having practically sufficient thermal conductivity and density can be provided.

In the heater tube for molten metal immersion of the above embodiment, a mounting part is equipped at an outer circumferential surface of the heater housing part, and a sleeve part having a diameter larger than the outer circumferential surface of the heater housing part is equipped at the mounting part.

By having such a configuration, the heater tube for molten metal immersion is easily installed at a holding furnace or the like.

### BRIEF DESCRIPTION OF DRAWINGS

FIG. 1 is a cross-sectional view schematically illustrating a heater tube for molten metal immersion of an embodiment of the present invention.

FIG. 2 is an enlarged cross-sectional view near an installation part schematically illustrating a state in which the heater tube for molten metal immersion of FIG. 1 is being horizontally installed at a holding furnace.

FIG. 3 is a perspective view illustrating an example of a sleeve part equipped in the heater tube of FIG. 1.

### BEST MODE(S) FOR CARRYING OUT THE INVENTION AND DETAILED DESCRIPTION

Hereinafter, a heater tube for molten metal immersion of an embodiment of the present invention will be described. However, the scope of the present invention is not limited to the embodiment.

A heater tube 1 for molten metal immersion of an embodiment of the present invention has a cylindrical heater housing part 4 equipped with a closed end 2 and an open end 3.

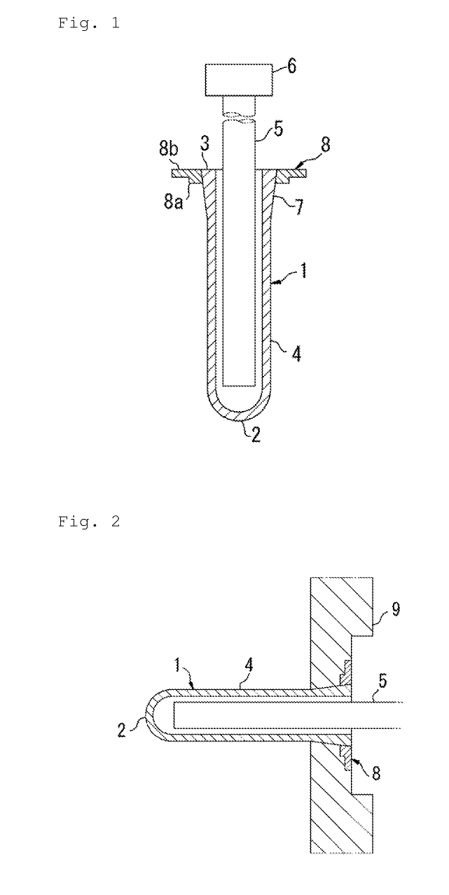

As illustrated in FIG. 1 or the like, the heater tube 1 is designed to a cylindrical shape, contains a heater 5 internally, is immersed into molten metal, and is heated. Incidentally, the reference number 6 in FIG. 1 is a power supply.

In the heater housing part 4, one end side is designed to be a closed end 2 which is immersed into molten metal or the like, and the other end side is designed to be an open end 3 in which the heater or the like is inserted thereto.

The closed end 2 is designed to a shape of swelling out hemispherically or semi-ellipsoidally, and the open end 3 is designed to a circular opening.

The heater housing part 4 may be designed to a size in conformity to a holding furnace or the like to be immersed. However, when the size is small, heating of the molten metal becomes difficult, and when the size is large, high strength or fracture toughness more than required is necessary. From such a viewpoint, a length of the heater housing part 4 is preferably 200 mm or more and 2,000 mm or less, and more preferably 600 mm or more and 1,500 mm or less. An outer diameter thereof is preferably 15 mm or more and 200 mm or less, and more preferably 50 mm or more and 160 mm or less. A thickness thereof is preferably 3 mm or more and 20 mm or less, and more preferably 5 mm or more and 13 mm or less.

As illustrated in FIG. 1 or FIG. 2, in the heater tube 1, a mounting part 7 can be equipped at an outer circumferential surface of the heater housing part 4.

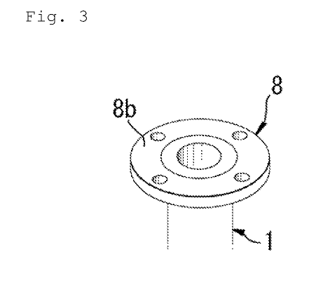

The mounting part 7 is installed near the open end 3, and is designed to a tapered shape of an outer circumferential surface part where contacting with an outer wall of the holding furnace. At the mounting part 7, a sleeve part 8 which is equipped with a cylindrical fixing part 8a having a diameter larger than the outer circumferential surface of the heater housing part 4 as illustrated in FIG. 3 can be mounted.

The sleeve part 8 can be mounted at the mounting part 7 via a filling material made of alumina, silicon carbide, or the like. The sleeve part 8 is equipped with a disc-shaped flange part 8b which protrudes outwardly, and can be used for mounting at a holding furnace 9 or the like as illustrated in FIG. 2.

It is preferable that the heater housing part 4 is made of a silicon nitride-based sintered body, and comprises silicon nitride (Si₃N₄), a compound containing yttrium, and a compound containing magnesium.

Examples of the compound containing yttrium may include Y₂O₃, Y₂Si₃O₃N₄, Y₄Si₂O₇N₂, oxynitride glass, or the like.

Examples of the compound containing magnesium may include MgO, Mg₂SiO₄, MgSiN₂, oxynitride glass, or the like.

It is preferable that the heater housing part 4 comprises a compound containing yttrium of 1.0 wt. % or more and 5.0 wt. % or less in terms of yttrium, and more preferably 1 wt. % or more and 3 wt. % or less. Also, it is preferable that the heater housing part 4 comprises a compound containing magnesium of 0.5 wt. % or more and 5.0 wt. % or less in terms of magnesium, and more preferably 1 wt. % or more and 3 wt. % or less.

It is preferable that the balance excluding the compound containing yttrium and the compound containing magnesium comprises only silicon nitride (Si₃N₄) of 75 wt. % or more, more preferably 80 wt. % or more, and inevitable impurities.

By being within the composition range, a sintered body having high strength and high thermal conductivity is obtained.

Incidentally, in the present invention, the inevitable impurities mean a very small quantity of other elements which are inevitably comprised in the sintered body other than silicon nitride, the compound containing yttrium, and the compound containing magnesium. In other words, the heater housing part 4 is substantially made of silicon nitride, the compound containing yttrium, and the compound containing magnesium.

In the heater housing part 4, it is preferable that a surface roughness Ra of an outer circumferential surface thereof is 0.5 μm or more and 10 μm or less, and more preferably 1 μm or more and 5 μm or less.

By being within the range, the thermal conductivity is enhanced.

It is assumed that this is because the outer circumferential surface is effectively contacted with an aluminum molten metal.

In the heater housing part 4, it is preferable that a surface roughness Ra of an inner circumferential surface thereof is 0.5 μm or more and 4.0 μm or less, and more preferably 0.6 μm or more and 3 μm or less. By being within the range, the thermal conductivity is enhanced. Further, it is preferable that the surface roughness Ra of the outer circumferential surface is larger than the surface roughness Ra of the inner circumferential surface by two times or more, and more preferably three times or more. By being within the range, a balance of the thermal conduction between an inner circumferential interface and an outer circumferential interface improves, and the thermal conductivity is furthermore enhanced.

The surface roughness Ra can be adjusted by performing an enclosing calcination and the like in a calcination step where a sintered body is being produced.

The surface roughness Ra can be measured according to JIS B 0601.

In the heater housing part 4, a closed porosity thereof is 15% or less, preferably 10% or less, and more preferably 5% or less. In addition, an open porosity thereof is 3% or less, and preferably 1% or less.

By being within the range, a sintered body having high strength and high thermal conductivity can be obtained.

The closed porosity and the open porosity can be adjusted by adjusting calcination conditions and the like.

As for the closed porosity, apparent density is measured according to JIS R 1634, and the closed porosity can be calculated from a ratio of theoretical density and the apparent density. Further, the open porosity can be determined according to JIS R 1634.

In the heater housing part 4, a bending strength thereof is 500 MPa or more, and more preferably 600 MPa or more.

By being within the range, the heater housing part 4 as a heater tube is hardly broken, can be stably used, and has a long service life.

The bending strength can be adjusted by densifying with a calcining profile and the like.

The bending strength means a three-point bending strength, and can be measured according to JIS R 1601.

In the heater housing part 4, a fracture toughness thereof is 5 MPa·(m)^{(1/2)} or more, and more preferably 7 MPa·(m)^{(1/2)} or more.

By being within the range, a generated crack is hardly progressed, a time to lead to fracture is extended, and the heater housing part 4 as a heater tube can be stably used.

The fracture toughness can be adjusted by changing a calcining profile and by densifying, and the like. Also, the fracture toughness can be adjusted by changing a calcining profile and by controlling a crystal particle diameter or a shape of silicon nitride, and the like.

The fracture toughness can be measured according to JIS R 1607.

In the heater housing part 4 of the heater tube 1, a thermal conductivity thereof is preferably 50 W/(m·K) or more, and more preferably 60 W/(m·K) or more. By being within the range, an amount of heat of the heater can be effectively conducted to molten metal as a heater tube. The thermal conductivity can be adjusted by controlling an amount of a compound containing yttrium or a compound containing magnesium, or by controlling a temperature profile, and the like.

The thermal conductivity can be measured according to JIS R 1611.

For example, the heater tube 1 of the present embodiment can be produced by the following production method.

The raw material contains 75 wt. % or more of silicon nitride, preferably 80 wt. % to 95 wt. %, and more preferably 85 wt. % to 94 wt. %. In the silicon nitride, α phase and β phase are present depending on the crystal structure, and it is good that the silicon nitride is a particle shape containing 50 vol. % or more, preferably 70 vol. % or more, and more preferably 85 vol. % or more in the raw material as the α phase. Hereby, a sintered body having high specific gravity and high strength can be obtained.

Further, the raw material contains 0.5 wt. % to 5 wt. % of a compound containing yttrium, and preferably 1 wt. % to 3 wt. %. As for the compound containing yttrium, yttria (Y₂O₃) is preferable. Since the yttria has no emission of a gas composition in the calcination step and further the yttria effectively functions as a sintering aid, a dense sintered body can be obtained.

Further, the raw material contains 0.5 wt. % to 5 wt. % of a compound containing magnesium, and preferably 1 wt. % to 3 wt. %. As for the compound containing magnesium, magnesia (MgO), forsterite (Mg₂SiO₄), and silicon nitride magnesium (MgSiN₂) are preferable. In addition, a compound in which water can be used as a solution while being prepared a slurry is excellent in respect of environment-friendly and low cost, and thus forsterite and silicon nitride magnesium are more preferable from such a viewpoint. Further, forsterite is more preferable since the material cost is inexpensive.

Each of the particles of such silicon nitride, the compound containing yttrium, and the compound containing magnesium is used as a raw material. Then, a binder such as polyvinyl alcohol, a dispersant, a plasticizer, and water are added thereto, and are stirred and mixed to obtain a slurry. The stirring and mixing can be performed with a ball mill or the like.

The slurry is dried by a spray-dry method so as to be a granule. An average particle diameter (D50) of the granule is preferably 30 μm to 200 μm, and more preferably 40 μm to 150 μm from a viewpoint of securing fluidity of the slurry while being prepared a compact, and density of the compact.

The average particle diameter (D50) of the granule can be measured by, for example, a laser diffraction and scattering method or the like.

Next, a compact will be produced by the following procedure. A die of the heater tube 1, in which a center core is set at a center of a cylindrical rubber die, is prepared, the granule is filled between the rubber die and the center core, and a gap of the rubber die and the center core is sealed in order to prevent intrusion of water from the outside of the rubber die. Thereafter, the rubber die is put in a CIP molding machine, and is formed by water pressure. At this time, the pressure value is preferably 0.8 t/cm² to 1.5 t/cm², and more preferably 0.9 t/cm² to 1.2 t/cm². Also, it is preferable to maintain the pressure for 0.2 minutes to 5 minutes, and more preferably 0.5 minutes to 1.5 minutes.

Afterwards, a compact is taken off from the rubber die, the center core is pulled out, and then a heater tube compact can be obtained.

The heater tube compact is calcined, thereby obtaining a heater tube 1.

At this time, the calcination temperature is preferably 1,700° C. to 2,100° C., and more preferably 1,800° C. to 2,000° C. Also, it is preferable to calcine for 3 hours to 20 hours, and more preferably 5 hours to 15 hours.

It is preferable that the calcination is performed under a nitrogen atmosphere, and the nitrogen partial pressure is gradually increased.

Further, as for the calcination, it is preferable to perform an enclosing calcination by using a container made of SiC fine ceramics.

By doing in this way, decomposition of the surface of the silicon nitride is suppressed, and a surface roughness of an outer circumferential surface of the heater housing part 4 becomes smooth.

The heater tube 1 according to the present invention is a heater tube for molten metal immersion comprising a silicon nitride-based sintered body having thermal conductivity or density higher than those of conventional products, and can be suitably used for a holding furnace or the like.

### EXAMPLES

Hereinafter, the heater tube for molten metal immersion according to the examples of the present invention will be described. However, the scope of the present invention is not limited to these examples.

### Production of Examples and Comparative Examples

Each of the heater tubes for molten metal immersion of Examples 1 to 4 and Comparative Examples 1 to 2 was produced.

(Production of Heater Tube for Molten Metal Immersion)

As for each of the heater tubes for molten metal immersion, silicon nitride (Si₃N₄) as a raw material, yttria (Y₂O₃) as an yttrium compound, and forsterite (Mg₂SiO₄) as a magnesium compound were used. The silicon nitride contains the α phase of 90 vol. %, and a purity thereof is 99%. Further, a purity of the yttria is 99.9%, and a purity of the forsterite is 98%. Average particle diameters and blending ratios, and the like of these are listed in Table 1 below. Incidentally, the average particle diameters of the raw materials were measured by a laser diffraction and scattering method.

Polyvinyl alcohol as a binder and water were added to these raw materials, and were stirred and mixed with a ball mill, thereby forming a slurry. Thereafter, the slurry was dried by a spray-dry method so as to be a granule, and the granule was filled in a rubber die having a shape of the heater tube. Average particle diameters of the granules are listed in Table 1 below. The average particle diameters of the granules were measured by a laser diffraction and scattering method.

Next, the rubber die was maintained for one minute under a pressure of 1 t/cm² by using a CIP molding machine (manufactured by Kobe Steel, Ltd.), and thus a compact was made. The compact was calcined at a temperature listed in Table 1 below for 10 hours under a nitrogen atmosphere, thereby producing a heater tube for molten metal immersion having a size of length 1,000 mm×outer dimension 112 mm×thickness 8 mm.

In this case, an enclosing calcination was conducted to Examples 1 to 4 by using a container made of SiC fine ceramics. As for Comparative Examples 1 to 2, the calcination was performed without enclosing with the container.

TABLE 1

| | | | | | | | Comparative | Comparative |
|---|---|---|---|---|---|---|---|---|
| | | | Example 1 | Example 2 | Example 3 | Example 4 | Example 1 | Example 2 |
| Production | Raw materials | Si₂N₄ | 92.5 | 90.6 | 97.5 | 86.0 | 92.5 | 92.5 |
| conditions | (wt. %) | Y₂O₃ | 3.59 | 3.41 | 1.20 | 86.70 | 3.59 | 3.59 |
| | | Mg₂SiO₄ | 3.91 | 5.95 | 1.30 | 7.30 | 3.91 | 3.91 |
| | | The amount in | 2.83 | 2.69 | 0.94 | 5.28 | 2.83 | 2.83 |
| | | terms of Y | | | | | | |
| | | The amount in | 2.24 | 3.41 | 0.45 | 2.52 | 2.24 | 2.24 |
| | | terms of Mg | | | | | | |
| | Average particle diameter of | | 1.0 | 1.1 | 1.1 | 1.1 | 1.1 | 10 |
| | raw material primary particle (μm) | | | | | | | |
| | Average particle diameter of granule (μm) | | 120 | 118 | 121 | 123 | 122 | 125 |
| | Calcination temperature (° C.) | | 1,950 | 1,950 | 1,950 | 1,850 | 1,950 | 1,780 |
| Characteristics | Surface roughness | Inner circumferential | 1.8 | 1.4 | 4.8 | 1.5 | 4.6 | 4.9 |
| of product | Ra (μm) | surface | | | | | | |
| | | Outer circumferential | 2.8 | 2.6 | 5.3 | 3.1 | 15.4 | 17.3 |
| | | surface | | | | | | |

| | | | | | | |
|---|---|---|---|---|---|---|
| Bending strength (MPa) | 650 | 640 | 400 | 600 | 660 | 300 |
| Fracture toughness (MPa · m\hat{ }(½)) | 10 | 9.8 | 4.3 | 5.2 | 10 | 4.7 |
| Thermal conductivity (W/m · K) | 73 | 71 | 42 | 22 | 70 | 28 |
| Closed porosity (%) | 2.43 | 2.13 | 3.11 | 15.9 | 2.43 | 10.3 |
| Open porosity (%) | 0.12 | 0.10 | 20.3 | 0.10 | 1.60 | 4.60 |
| Kind of compounds containing | Y₄Si₂O₇N₂, | Y₄Si₂O₇N₂, | None | Y₄Si₂O₇N₂, | Y₄Si₂O₇N₂, | Y₄Si₂O₇N₂, |
| yttrium of sintered body | Y₂Si₃O₃N₄ | Y₂Si₃O₃N₄ | | Y₂Si₃O₃N₄ | Y₂Si₃O₃N₄ | Y₂Si₃O₃N₄ |
| Temperature inside the heater tube when | 850 | 840 | 870 | 880 | 940 | 1,010 |
| using as a heater tube (° C.) | | | | | | |
| (controlling so as to be 700° C. of | | | | | | |
| aluminum molten metal temperature) | | | | | | |

(Measurement of Physical Property Values of the Heater Tube for Molten Metal Immersion)

Physical property values of each of the heater tube for molten metal immersion were measured.

(Surface Roughness)

Surface roughness Ra was measured according to JIS B 0601. The results are listed in Table 1 mentioned above.

(Open Porosity)

Open porosity was measured according to JIS R 1634 as an apparent porosity described in the standard. The results are listed in Table 1 mentioned above.

(Closed Porosity)

As for closed porosity, apparent density was measured according to JIS R 1634, and the closed porosity was calculated from a ratio of theoretical density and the apparent density. The results are listed in Table 1 mentioned above.

(Thermal Conductivity)

Thermal conductivity was measured according to JIS R 1611 as a thermal conductivity described in the standard. The results are listed in Table 1 mentioned above.

(Bending Strength)

Measurement of bending strength was performed by a three-point bending test according to JIS R 1601. The results are listed in Table 1 mentioned above.

(Fracture Toughness)

Fracture toughness was measured according to JIS R 1607 by performing a fracture resistance test described in the standard. The results are listed in Table 1 mentioned above.

(Powder X-Ray Diffraction)

A sintered body was pulverized, and a powder X-ray diffraction measurement was performed, thereby analyzing a kind of compounds containing yttrium. The results are listed in Table 1 mentioned above.

(Evaluation when Using as a Heater Tube)

By using each of the heater tubes of Examples and Comparative Examples, a holding furnace illustrated in FIG. 2 was fabricated. Aluminum was molten by heating a heater, and the heater output was controlled such that a temperature of the molten aluminum was to be 700° C. A temperature near the heater inside the heater tube in one hour after being 700° C. was measured. The results are listed in Table 1 mentioned above.

In each of Examples 1 to 4, the surface roughness (Ra) is small, the surface is being smooth, and the thermal conductivity is also high. Further, the bending strength and the fracture toughness are also the values in which the heater tube can be endured for a practical use.

In contrast, in each of Comparative Examples 1 to 2, the surface roughness (Ra) is large, the surface is being rough, and the thermal conductivity is also low. Further, the bending strength and the fracture toughness are also low and the values in which the heater tube cannot be practically used.

In each of Examples 1 to 4, since the heater temperature is low and the surface roughness is small as compared with Comparative Examples 1 to 2, it can be said that an amount of heat is effectively conducted to aluminum. Conversely, in each of Comparative Examples 1 to 2, since the surface roughness is large, bubbles are easily gathered at an outer surface of the heater tube, and thus an amount of heat cannot be effectively conducted. That is, since the aluminum temperature is controlled at 700° C. constantly, it is necessary to further enhance the temperature near the heater by heating the heater excessively, which result in overspending the excessive power.

1. A heater tube for receiving a heating element for molten metal immersion, the heater tube comprising a cylindrical heater housing part equipped with a closed end and an open end, wherein the heating element is received in an interior of the cylindrical heater housing part,
the heater housing part comprises silicon nitride, a compound comprising yttrium, and a compound comprising magnesium, and
a surface roughness Ra of an outer circumferential surface of the heater housing part is 0.5 μm or more and 10 μm or less.

2. The heater tube according to claim 1, wherein
the compound containing yttrium is at least one or more selected from Y₂O₃, Y₂Si₃O₃N₄, Y₄Si₂O₇N₂, and oxynitride glass of yttrium, and is 1.0 wt. % or more and 5.0 wt. % or less in terms of yttrium, the compound containing magnesium is at least one or more selected from MgO, Mg₂SiO₄, MgSiN₂, and oxynitride glass of magnesium, and is 0.5 wt. % or more and 5.0 wt. % or less in terms of magnesium which are respectively comprised in the heater housing part, and
the balance excluding the yttrium compound and the magnesium compound is a silicon nitride of 75 wt. % or more and inevitable impurities.

3. The heater tube according to claim 1, wherein a closed porosity of the heater housing part is 15% or less.

4. (canceled)

5. The heater tube according to claim 1, wherein
a length of the heater housing part is 200 mm or more and 2,000 mm or less,
an outer diameter thereof is 15 mm or more and 200 mm or less, and
a thickness thereof is 3 mm or more and 20 mm or less.

6. The heater tube according to claim 1, wherein a surface roughness Ra of an inner circumferential surface of the heater housing part is 0.5 μm or more and 4.0 μm or less.

7. The heater tube according to claim 1, wherein a thermal conductivity of the heater housing part is 50 W/(m·K) or more.

8. The heater tube according to claim 1, wherein a bending strength of the heater housing part is 500 MPa or more.

9. The heater tube according to claim 1, wherein a fracture toughness of the heater housing part is 5 MPa·(m)^{(1/2)} or more.

10. The heater tube according to claim 1, wherein an open porosity of the heater housing part is 3% or less.

11. The heater tube according to claim 1, wherein
a mounting part is equipped at an outer circumferential surface of the heater housing part, and
a sleeve part having a diameter larger than the outer circumferential surface of the heater housing part is equipped at the mounting part.
